(19) United States
(12) Patent Application Publication
(10) Pub. No.: US 2010/0142913 A1
(43) Pub. Date: Jun. 10, 2010

(54) VIDEO-AUDIO RECORDING APPARATUS, AND VIDEO-AUDIO RECORDING METHOD

(75) Inventor: Masayuki Hasegawa, Tokyo (JP)

Correspondence Address: Christensen O'Connor Johnson Kindness PLLC, 1420 Fifth Avenue, Suite 2800, Seattle, WA, 98101-2347, US

(73) Assignee: Matsushita Electric Industrial Co., Ltd., Osaka (JP)

(21) Appl. No.: 12/067,646

(22) PCT Filed: Sep. 21, 2006
(86) PCT No.: PCT/JP2006/318765

§ 371 Date: Mar. 20, 2008

(30) Foreign Application Priority Data
Sep. 22, 2005 (JP) 2005-276533

(51) Int. Cl. H04N 5/93; H04N 5/91

(52) U.S. Cl. 386/52; 386/96; 386/E05.003

(57) ABSTRACT

Provided is a video-audio recording apparatus capable of executing a transition effect processing simply simultaneously with an image pickup. In this apparatus, a setting unit (121) of a transition effect unit (106) registers a transition effect in accordance with an input selected from a transition effect setting screen by an operation unit (102). An extraction unit (122) extracts an area to be superposed for executing a transition effect processing. After an “image pickup resumption”, an effect processing unit (123) synthesizes a video signal inputted from a video input device (103) and an audio signal inputted from an audio input device (104), and a video signal and an audio signal to be recorded in the area extracted at the extraction unit (122), thereby to execute the transition effect processing.

### TECHNICAL FIELD

The present invention relates to a video and audio recording apparatus and video and audio recording method. More particularly, the present invention relates to a video and audio recording apparatus and video and audio recording method that, when recording video and audio with temporal continuity being lost by a pause of filming, after resuming the filming, connects the video and audio while providing special effects automatically.

### BACKGROUND ART

Conventionally, users improve visual effects and enjoy filming video by cutting unnecessary parts in filmed video using commercially available video editing software after filming video, providing special effects such as filtering effects to filmed video, and performing editing work such as connecting necessary scenes. When scenes are connected in such an editing work, to avoid a sudden switch to the next scene, a transition effect is often used to display a connection of a scene and the next scene redundantly for a few seconds so that the scene is switched to the next scene gradually.

Providing a transition effect requires work and time for reading a scene and the next scene to be connected at the same time, converting and editing the read data, converting the edited data again and recording the data as a file. In addition, skills are required to set a transition effect, and there is an image editing apparatus that sets an optimum transition effect automatically (for example, see Patent Document 1).

The image editing apparatus of Patent Document 1 has: a recording section that records a plurality of images and image attribute information; a visual effect recording section that records the image attribute information and visual effects upon image switching, in association with each other; and an image connecting section that, when there is corresponding information in the image attribute information to be connected, provides a visual effect recorded in the visual effect recording section and connects both images, and, when images having the same image attribute information are connected, a transition effect recorded in the visual effect recording section is set automatically.

### Patent Document 1: Japanese Patent Application Laid-Open No. 2004-120544 (FIG. 6)

### DISCLOSURE OF INVENTION

### Problems to be Solved by the Invention

However, the image editing apparatus of Patent Document 1 needs to record image attribute information such as filming date, filming time, zoom information, user name and filming location, every time filming is performed, and cannot implement transition effect processing without recording video as a file, and therefore, to provide a transition effect to the filmed video, it is necessary to purchase an image editing apparatus in addition to a video filming apparatus and perform editing work using the image editing apparatus after filming. Particularly, compact, portable video and audio recording apparatuses such as mobile phones have a problem that, as a result of frequent repetition of short-time filming, when the recorded video is played back, scenes switch suddenly and are uncomfortable to watch.

It is therefore an object of the present invention to provide a video and audio recording apparatus and video and audio recording method that make it possible to implement transition effect processing at the same time as filming in a simple manner.

### Means for Solving the Problem

The video and audio recording apparatus of the present invention has: an input device that captures video data and audio data being filmed; a transition effect registering section that registers a transition effect of connecting video data and audio data recorded before and after filming is paused; an editing section that, when the filming is paused and then resumed, edits the video data and audio data according to the transition effect registered by the transition effect registering section; and a recording section that records the video data and audio data inputted from the input device or the video data and audio data edited by the editing section.

The video and audio recording method of the present invention has: a registering step of registering a transition effect of connecting video data and audio data recorded before and after filming is paused; an inputting step of capturing video data and audio data being filmed; an editing step of editing the video data and audio data according to the transition effect registered in the registering step; and a recording step of recording one of the video data and audio data captured in the inputting step and the video data and audio data edited in the editing step.

### ADVANTAGEOUS EFFECT OF THE INVENTION

According to the present invention, it is possible to implement transition effect processing at the same time as filming in a simple manner.

### BRIEF DESCRIPTION OF DRAWINGS

FIG. 1 is a block diagram showing a configuration of a video and audio recording apparatus according to Embodiment 1 of the present invention;

FIG. 2 is a block diagram showing a configuration of a transition effect section according to Embodiment 1 of the present invention;

FIG. 3A shows an example of a transition effect setting screen according to Embodiment 1 of the present invention;

FIG. 3B shows another example of the transition effect setting screen according to Embodiment 1 of the present invention;

FIG. 4 illustrates transition effect processing when a moving picture or audio is selected, according to Embodiment 1 of the present invention;

FIG. 5 illustrates transition effect processing when an image or sound is selected, according to Embodiment 1 of the present invention;

FIG. 6 is a flowchart illustrating the operation of the video and audio recording apparatus according to Embodiment 1 of the present invention;

FIG. 7 is a flowchart illustrating the transition effect processing according to Embodiment 1 of the present invention;

FIG. 8 is a block diagram showing a configuration of a video and audio recording apparatus according to Embodiment 2 of the present invention;

FIG. 9 is a functional block diagram showing a configuration of a transition effect section according to Embodiment 2 of the present invention;

FIG. 10A shows an example of a transition effect setting screen according to Embodiment 2 of the present invention;

FIG. 10B shows another example of the transition effect setting screen according to Embodiment 2 of the present invention;

FIG. 11A shows still another example of the transition effect setting screen according to Embodiment 2 of the present invention;

FIG. 11B shows yet another example of the transition effect setting screen according to Embodiment 2 of the present invention;

FIG. 12 is a flowchart illustrating the operation of the video and audio recording apparatus according to Embodiment 2 of the present invention; and

FIG. 14 is a flowchart illustrating the operation of transition effect processing according to Embodiment 2 of the present invention.

### BEST MODE FOR CARRYING OUT THE INVENTION

Embodiment 1 and Embodiment 2 of the present invention will be described in detail below with reference to the accompanying drawings. In Embodiment 1, when video and audio with temporal continuity being lost by a pause of filming, are recorded after filming is resumed, the transition effect processing is implemented by superimposing video data and audio data after filming is resumed and video data and audio data immediately before the pause. In Embodiment 2, when video and audio with temporal continuity being lost by a pause of filming, are recorded after filming is resumed, the transition effect processing is implemented by superimposing video data and audio data other than video data and audio data immediately before the pause and video data and audio data after filming is resumed.

### Embodiment 1

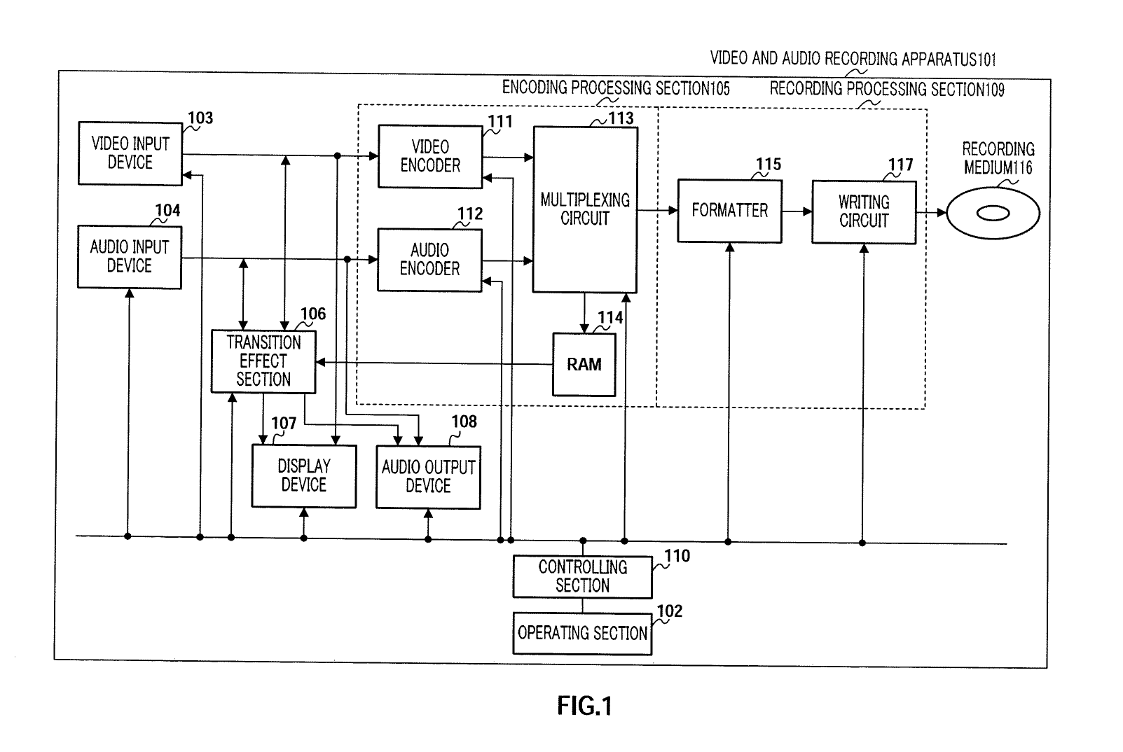

FIG. 1 is a block diagram showing the configuration of the video and audio recording apparatus according to Embodiment 1 of the present invention. As shown in FIG. 1, video and audio recording apparatus 101 has the following sections connected to controlling section 110: operating section 102 that allows a user to input operations such as “start filming,” “finish filming,” “pause,” “resume filming” or “save as a file” using operation buttons or the like; video input device 103 that inputs a video signal being filmed by a camera or the like; audio input device 104 that inputs an audio signal by a microphone or the like; encoding processing section 105 that encodes the video signal and the audio signal inputted from video input device 103 and audio input device 104 and temporarily records the encoded video signal and audio signal; transition effect section 106 that implements transition effect processing by combining video data and audio data before a pause recorded in encoding processing section 105 and the video signal or audio signal inputted from video input device 103 and audio input device 104 by the operation of “resume filming”; display device 107 that displays a transition effect setting screen for registering the type of a transition effect and video being filmed or video subjected to the transition effect; audio output device 108 that outputs audio being filmed or audio subjected to the transition effect; and recording processing section 109 that performs recording processing according to recording medium 116.

Encoding processing section 105 receives video signals from video input device 103 and transition effect section 106 and receives audio signals from audio input device 104 and transition effect section 106.

Encoding processing section 105 has video encoder 111 that compresses and encodes received video signals according to a video compression scheme such as MPEG4 (Moving Picture Coding Experts Group 4) VIDEO to generate a video stream; audio encoder 112 that compresses and encodes the received audio signals according to an audio compression scheme such as MPEG4 AAC (Advanced Audio Coding) to generate an audio stream; multiplexing circuit 113 that is connected to video encoder 111 and audio encoder 112 and that multiplexes the video stream and audio stream to generate a multiplexed stream of video and audio; and RAM 114 that records the multiplexed stream of video and audio temporarily.

It is also possible to record a video stream and audio stream in RAM 114 separately without multiplexing.

Recording processing section 109 has: formatter 115 that formats the multiplexed stream recorded in RAM 114 when “save as a file” is inputted from operating section 102; and writing circuit 117 that writes the formatted multiplexed stream in recording medium 116.

Controlling section 110 is connected to video input device 103, audio input device 104, transition effect section 106, display device 107, audio output device 108, video encoder 111, audio encoder 112, multiplexing circuit 113, formatter 115 and writing circuit 117, and controls them according to the input from operating section 102.

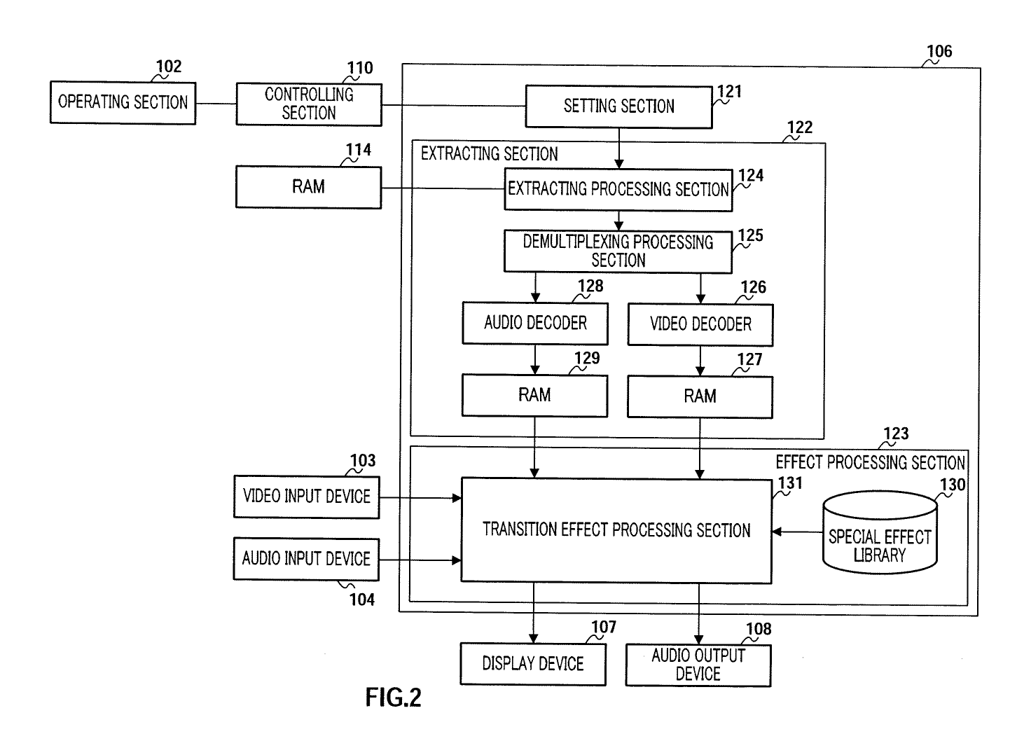

FIG. 2 is a block diagram showing a configuration of a transition effect section according to Embodiment 1 of the present invention. Transition effect section 106 has: setting section 121 that registers a transition effect through controlling section 110 according to the input selected by operating section 102 on a transition effect setting screen which is displayed on display device 107; extracting section 122 that extracts an area for implementing transition effect processing by superimposing the video signal inputted from video input device 103 and the audio signal inputted from audio input device 104 after “resume filming”; and effect processing section 123 that implements the transition effect processing by combining the video signal inputted from video input device 103 and the audio signal inputted from audio input device 104 after “resume filming” and the video signal and the audio signal recorded in the area extracted by extracting section 122.

Extracting section 122 has: extracting processing section 124 that extracts an area for combining a video signal and audio signal inputted after “resume filming” from the multiplexed stream in a filmed recording file recorded in RAM 114; demultiplexing processing section 125 that demultiplexes the multiplexed stream of video and audio recorded in the extracted area into a video stream and an audio stream; video decoder 126 that decodes the demultiplexed video stream into a video signal; RAM 127 that records the decoded video signal; audio decoder 128 that decodes the demultiplexed audio stream into an audio signal; and RAM 129 that records the decoded audio signal, and extracting section 122 extracts a video signal to be a target of combining processing and an audio signal to be a target of combining processing, records the extracted video signal in RAM 127, and records the extracted audio signal in RAM 129.

When a video stream and audio stream are not multiplexed and recorded in RAM 114 separately, demultiplexing processing section 125 is not required.

Effect processing section 123 has: special effect library 130 that stores a program or template for implementing transition effect processing; transition effect processing section 131 that implements transition effect processing by combining a video signal to be a target of combining processing, which is recorded in RAM 127, and an audio signal to be a target of combining processing, which is recorded in RAM 129, and a video signal and audio signal newly inputted from video input device 103 and audio input device 104 through filming.

The video subjected to the transition effect by transition effect processing section 131 is displayed on display device 107, and the audio which is also subjected to the transition effect by transition effect processing section 141 is outputted to audio output device 108.

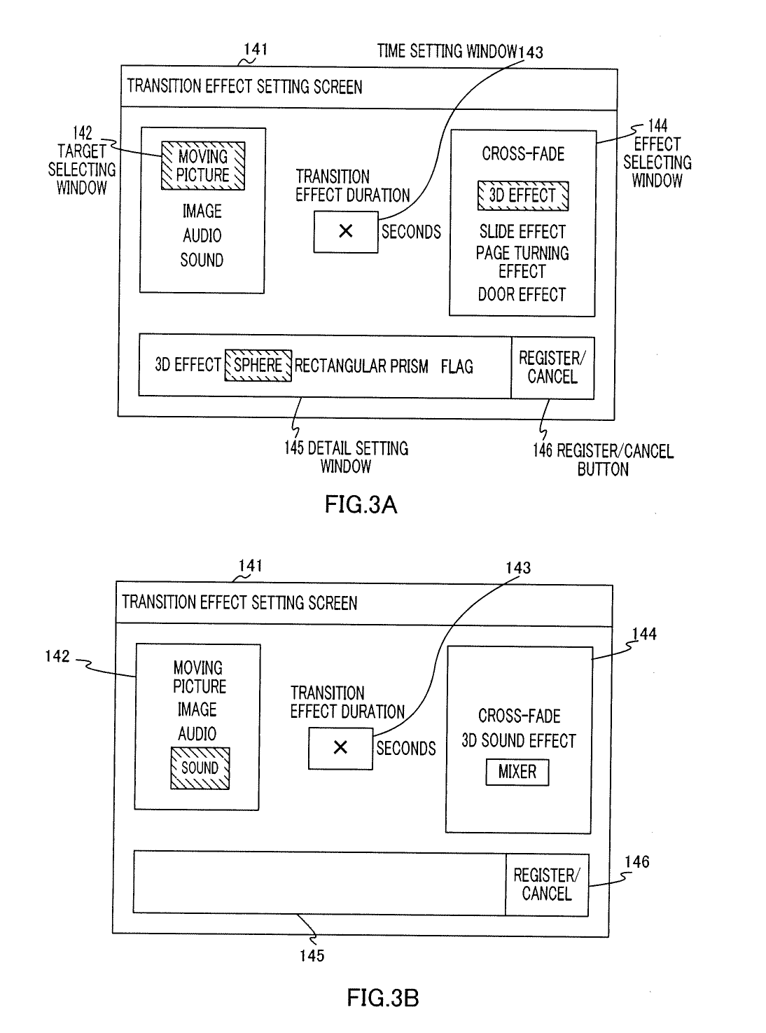

FIG. 3A and FIG. 3B show examples of the transition effect setting screen according to Embodiment 1 of the present invention. As shown in FIG. 3A and FIG. 3B, transition effect setting screen 141 includes: target selecting window 142 for selecting a target of combining with video or audio filmed by “resume operation,” from “moving picture,” “image,” “audio” and “sound” immediately before “pause”; time setting window 143 for setting a transition effect duration of X seconds; effect selecting window 144 for selecting the type of a transition effect; detail setting window 145 for setting detailed editing conditions of the transition effect selected in effect selecting window 144; and register/cancel button 146.

Transition effect setting screen 141 is displayed on display device 107 when “pause” is inputted before “start filming” or during filming. The user can select a desired item in each window of transition effect setting screen 141 and register or cancel the transition effect processing to be implemented by register/cancel button 146.

The items displayed in target selecting window 142 include: “moving picture” for implementing transition effect processing on moving picture for X seconds, immediately before “pause” as a target of combining; “image” for implementing transition effect processing on the last single image recorded immediately before “pause” as a target of combining; “audio” for implementing transition effect processing on audio for X seconds, immediately before “pause” as a target of combining; and “sound” for implementing transition effect processing on the last single sound recorded immediately before “pause” as a target of combining, and a target for combining with the video signal and audio signal inputted by “resume filming” is selected.

When a transition effect is registered, unless transition effects contradict each other, a plurality of transition effects can be registered at the same time by using transition effect setting screen 141 repeatedly. When “moving picture” or “audio” is selected in target selecting window 142 upon transition effect registration, by registering “moving picture” and “audio” in combination, video and audio can be switched to video and audio after “resume filming” more smoothly.

In the same way, when “moving picture” or “sound” is selected in target selecting window 142, although video and audio can be switched to video and audio after “resume filming” smoothly by registering “image” and “sound” in combination, it is also possible to implement transition effect processing by registering only “image” or “sound.”

As shown in FIG. 3A, when “moving picture” is selected in target selecting window 142, effect selecting window 144 displays “cross-fade” for superimposing transparent video after “pause” on “moving picture” X seconds before “pause” and displaying the superimposed video, “3D effect” for switching to video after “resume filming” by pasting video X seconds before “pause” to a surface of a three-dimensional object such as a sphere, rectangular prism and flag, rotating the stationary sphere, rectangular prism and flag, and sliding out them to an edge of the screen, “slide effect” for switching from video X seconds before “pause” to video after “resume filming” while sliding them, “page turning effect” for switching to video after “resume filming” by turning over video X seconds before “pause” as if a page of a book is turned over, and “door effect” for switching video after “resume filming” after the operation of opening video X seconds before “pause” as if window opens.

“Cross-fade” is a transition effect for, first, displaying video X seconds before “pause” with low transparency, increasing the transparency of the video X seconds before “pause” gradually with the passage of time, that is, fading out the video, and, at the same time, decreasing the transparency of video after “resume filming” and fading in the video after “resume filming,” and, after X seconds, switching to video being filmed.

As shown in FIG. 3B, when “sound” is selected in target selecting window 142, effect selecting window 144 displays “cross-fade” for, first, outputting sound immediately before “pause,” gradually fading out the sound immediately before “pause” with the passage of time, and, at the same time, fading in sound after “resume filming,” and, after X seconds, switching to sound being filmed, “3D sound effect” for making sound immediately before “pause” and sound after “resume filming” to be heard in an overlapped manner and in a three-dimensional manner for a transition effect duration of X seconds, and “mixer” for making sound immediately before “pause” and sound after “resume filming” to be heard in a mixed manner for a transition effect duration of X seconds.

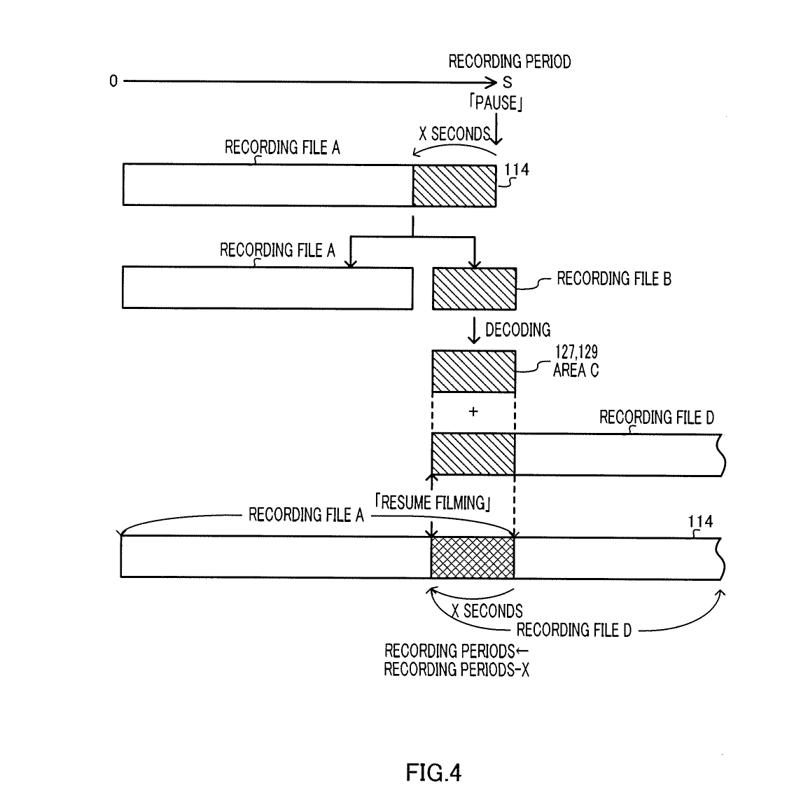

FIG. 4 illustrates transition effect processing when moving picture or audio is selected, according to Embodiment 1 of the present invention. As shown in FIG. 4, the multiplexed stream multiplexing video and audio until immediately before “pause,” is recorded in RAM 114.

If the multiplexed stream recording video and audio until immediately before “pause” is recording file A, recording file A recorded for recording period S is sought in the reverse direction for the transition effect duration of X seconds, and recording file B of X seconds is extracted. The multiplexed stream of recording file B is demultiplexed into a video stream and an audio stream, the video stream is decoded into a video signal by video decoder 126 and recorded in area C in RAM 127, and, in parallel with this, the audio stream is decoded into an audio signal by audio decoder 128 and recorded in area C in RAM 129.

When “moving picture” is selected in target selecting window 142, upon “resume filming,” the transition effect processing selected in effect selecting window 144 is implemented by combining the video signal recorded in area C in RAM 127 and a video signal newly captured by video input device 103 for the transition effect duration of X seconds.

When “audio” is selected in target selecting window 142, upon “resume filming,” transition effect processing selected in effect selecting window 144 is implemented by combining the audio signal recorded in area C in RAM 129 and an audio signal newly captured by audio input device 104 for the transition effect duration of X seconds.

Recording file B is combined with video data and audio data recorded after “resume filming” and is newly recorded as recording file D, and so recording period S after “resume filming” is reduced by the transition effect duration of X seconds, and new recording processing is started.

By implementing transition effect processing of combining the video signal of “moving picture” of X seconds before “pause” and the video signal after “resume filming,” or by implementing transition effect processing of combining the audio signal of “audio” of X seconds before “pause” and the audio signal after “resume filming,” video or audio before “pause” and video or audio after “resume filming,” which do not have temporal continuity, are connected smoothly.

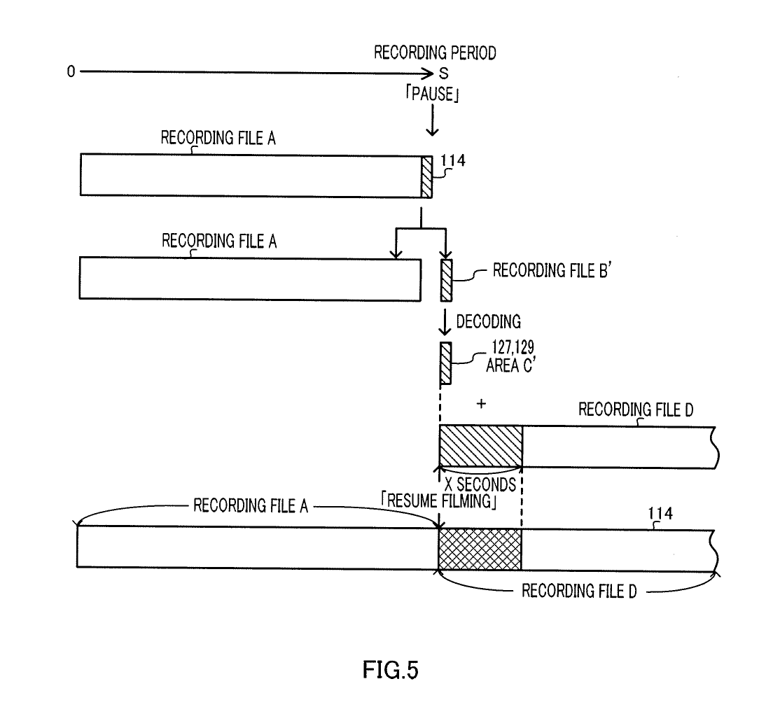

FIG. 5 illustrates transition effect processing when image or sound is selected, according to Embodiment 1 of the present invention. As shown in FIG. 5, the multiplexed stream multiplexing video and audio immediately before “pause” is recorded in RAM 114.

If the multiplexed stream of recording video and audio until immediately before “pause” is recording file A, recording file B′ of “image” or “sound” recorded in the last part of recording file A which is recorded for recording period S, is extracted. The multiplexed stream of recording file B′ is demultiplexed into a video stream and an audio stream, the video stream is decoded into a video signal by video decoder 126 and recorded in area C′ in RAM 127, and, in parallel with this, the audio stream is decoded into an audio signal by audio decoder 128 and recorded in area C′ in RAM 129.

If “image” is selected in target selecting window 142, upon “resume filming,” transition effect processing selected in effect selecting window 144 is implemented by combining a video signal of the last “image” recorded in area C′ in RAM 127 and a video signal newly captured by video input device 103 for the transition effect duration of X seconds.

If “sound” is selected in target selecting window 142, upon “resume filming,” transition effect processing selected in effect selecting window 144 is implemented by combining an audio signal of the last “sound” recorded in area C′ in RAM 129 and an audio signal newly captured by audio input device 104 for the transition effect duration of X seconds.

Although recording file B′ is combined with video data and audio data recorded after “resume filming” and is newly recorded as recording file D, the data is a finally recorded single image or single sound, and so new recording processing is started with recording period S as is.

By implementing transition effect processing of combining the video signal of the last “image” immediately before “pause” and the video signal after “resume filming” for X seconds, or by implementing transition effect processing of combining the audio signal of “sound” immediately before “pause” and the audio signal after “resume filming” for X seconds, video or audio before “pause” and video or audio after “resume filming,” which do not have temporal continuity, are smoothly connected.

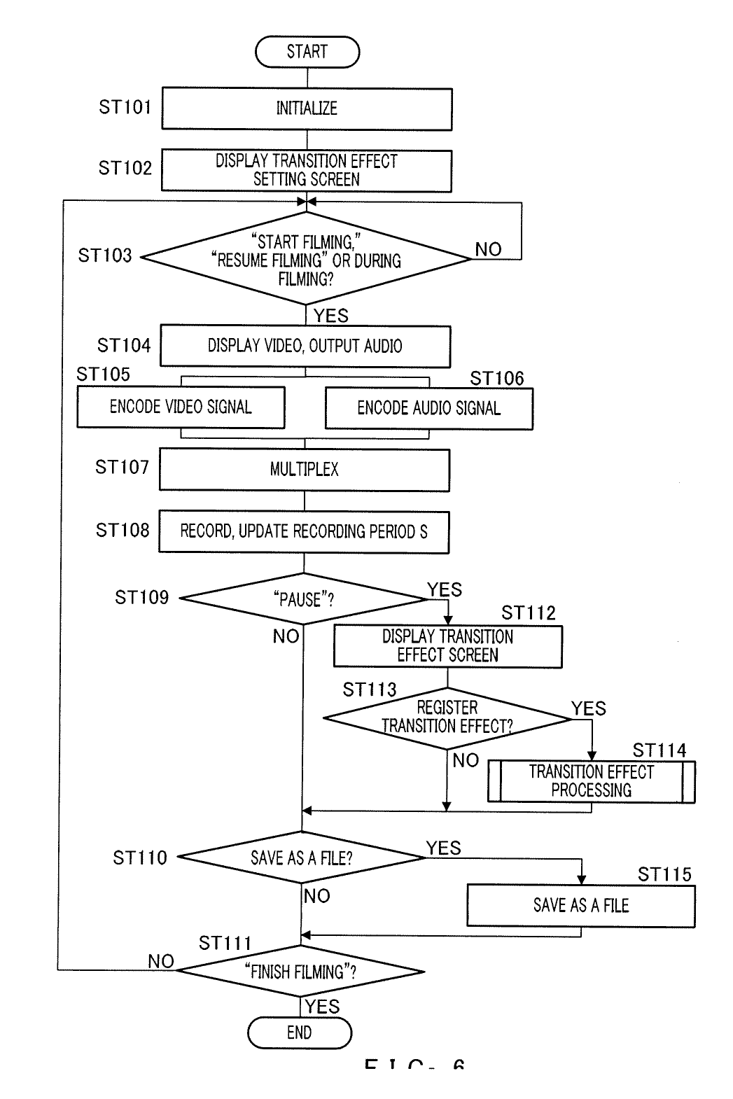

The operation of video and audio recording apparatus 101 configured as described above will be described. FIG. 6 is a flowchart illustrating the operation of the video and audio recording apparatus according to Embodiment 1 of the present invention. As shown in FIG. 6, when the user turns on the power of video and audio recording apparatus 101, video input device 103, audio input device 104, display device 107 and audio output device 108, for example, camera, microphone, liquid crystal display and speaker, and recording period S of recording file A of video and audio recording apparatus 101 are initialized (ST101), and transition effect setting screen 141 is displayed on display device 107 (ST102).

The user can select, register and cancel the type of the transition effect the user wants to implement upon filming by transition effect setting screen 141 displayed on display device 107.

When “start filming” is inputted through operating buttons by operating section 102 and recording of video and audio is started (ST103: “Yes”), a video signal is captured from video input device 103 and displayed on display device 107, and an audio signal is captured from audio input device 104 and outputted to audio output device 108 (ST104), the video signal captured from video input device 103 is compressed and encoded by video encoder 111 to generate a video stream (ST105), and, in parallel with this, the audio signal captured from audio input device 104 is compressed and encoded by audio encoder 112 to generate an audio stream (ST106), the video stream and audio stream are multiplexed by multiplexing circuit 113 to generate a multiplexed stream (ST107), and, as shown in FIG. 4 and FIG. 5, the generated multiplexed stream of video and audio is recorded in recording file A in RAM 114, and recording period S is updated (ST108).

If none of “pause,” “save as a file” and “finish filming” is inputted from operating section 102 (ST109: “No,” ST110: “No,” ST111: “No”), the flow returns to ST103, and, during filming (ST103: “Yes”), processings from ST104 to ST111 are repeatedly carried out, the multiplexed stream of video and audio is recorded in recording file A in RAM 114, and recording period S is updated.

In ST109, when “pause” of filming is inputted from operating section 102 (ST109: “Yes”), filming is paused, and transition effect setting screen 141 is displayed on display device 107 (ST112).

The user can register, re-register or cancel a transition effect by transition effect setting screen 141 displayed on display device 107. Here, if the transition effect is registered (ST113: “Yes”), transition effect processing is implemented (ST114).

In ST113, if a transition effect is not registered (ST113: “No”) and neither “save as a file” nor “finish filming” is inputted (ST110: “No,” ST111: “No”), return to ST103, and the processing is idle until “resume filming” is inputted from operating section 102 (ST103: “No”).

If “resume filming” is inputted in ST103 (ST103: “Yes”), the processings from ST104 to ST111 are repeated, the multiplexed stream of video and audio after “resume filming” is continuously recorded as recording file D in recording file A in RAM 114, and recording period S is updated.

In ST110, if “save as a file” is inputted (ST110: “Yes”), the multiplexed stream of recording file A including recording file D recorded in RAM 114 is formatted by formatter 115 and saved in recording medium 116 per recording block unit by writing circuit 117 (ST115), and until “finish filming” is inputted (ST111: “No”), return to ST103, and the processing is continued.

In ST111, if “finish filming” is inputted (ST111: “Yes”), the processing of video and audio recording apparatus 101 is finished.

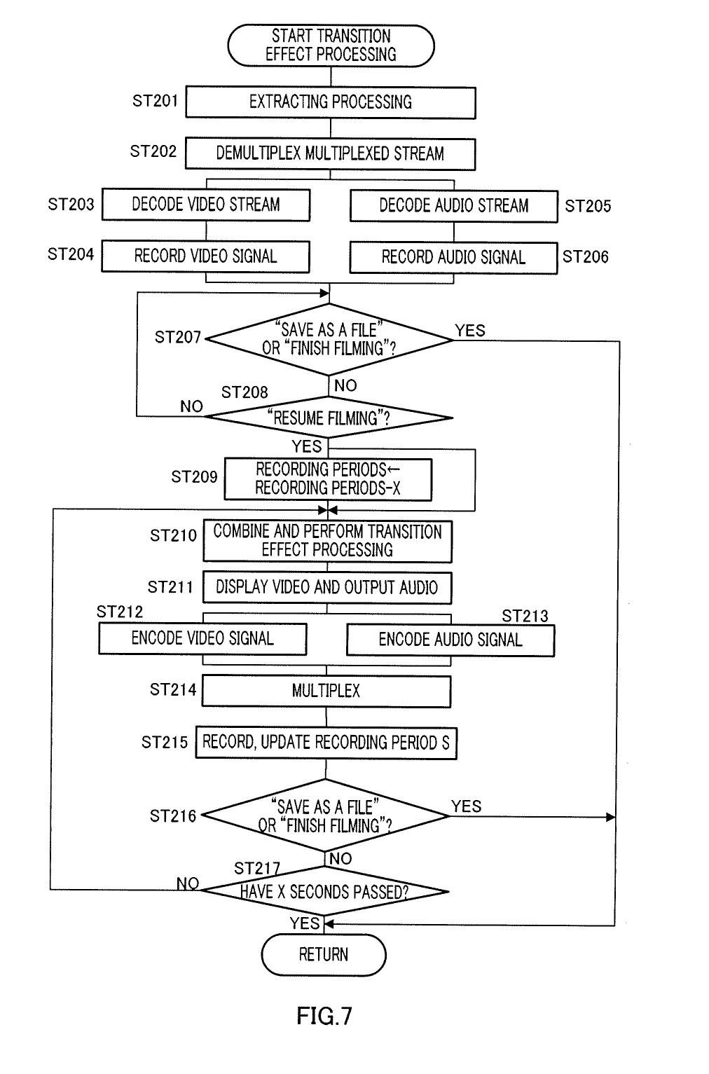

FIG. 7 is a flowchart illustrating the operation of transition effect processing according to Embodiment 1 of the present invention. First, processing of extracting a video or audio file to be a target of combining processing is carried out (ST201). As shown in FIG. 4 and FIG. 5, recording file A in RAM 114 where the multiplexed stream is recorded until immediately before “pause” is sought in reverse direction for the transition effect duration of X seconds, and recording file B or recording file B′ of X seconds is extracted.

The multiplexed stream of recording file B or recording file B′ is demultiplexed into a video stream and an audio stream (ST202), the video stream is decoded into a video signal by video decoder 126 (ST203) and recorded in area C or area C′ in RAM 127 (ST204), and in parallel with this, the audio stream is decoded into an audio signal by audio decoder 128 (ST205) and recorded in area C or area C′ in RAM 129 (ST206).

If neither “save as a file” nor “finish filming” is inputted from operating section 102 (ST207: “No”), until “resume filming” is inputted from operating section 102, the processing is idle in that state.

In ST207, if “save as a file” or “finish filming” is inputted (ST207: “Yes”), transition effect processing is finished, return to ST110 in FIG. 6, and processing of saving as a file or processing of finishing filming is carried out.

In ST207, if neither “save as a file” nor “finish filming” is inputted (ST207: “No”) and “resume filming” is inputted (ST208: “Yes”), processing of reducing recording period S of recording file A by the transition effect duration of X seconds, is carried out when “moving picture” or “audio” is selected in target selecting window 142 (ST209), and the processing is not carried out when “image” or “sound” is selected in target selecting window 142.

Next, when “moving picture” or “image” is selected in target selecting window 142, transition effect processing selected in effect selecting window 144 is implemented by combining a video signal recorded in area C or area C′ in RAM 127 and a video signal newly captured by video input device 103. When “audio” or “sound” is selected in target selecting window 142, transition effect processing selected in effect selecting window 144 is implemented by combining an audio signal recorded in area C or area C′ in RAM 129 and an audio signal newly captured by audio input device 104 (ST210). The video signal subjected to the transition effect is displayed on display device 107, and the audio signal subjected to transition effect is outputted to audio output device 108 (ST211).

Next, the video signal subjected to the transition effect is compressed and encoded by video encoder 111 to generate a video stream (ST212), and, in parallel with this, the audio signal subjected to the transition effect is compressed and encoded by audio encoder 112 to generate an audio stream (ST213), the video stream and audio stream are multiplexed by multiplexing circuit 113 (ST214), the multiplexed stream of video and audio is recorded according to recording period S of recording file A in RAM 114, and recording period S is updated (ST215).

If neither “save as a file” nor “finish filming” is inputted from operating section 102 (ST216: “No”), until the transition effect duration of X seconds passes (ST217: “No”), return to ST210, and the processings from ST210 to ST217 are carried out, transition effect processing of combining a video signal before “pause” and a video signal filmed after “resume filming” for the transition effect duration of X seconds, and transition effect processing of combining an audio signal before “pause” and an audio signal filmed after “resume filming” for the transition effect duration of X seconds, are implemented, and, when the transition effect duration of X seconds passes (ST217: “Yes”), transition effect processing is finished, return to ST110 in FIG. 6, and the processing is continued.

In this way, the video and audio before “pause” and the video and audio after “resume filming,” which have no temporal continuity, are connected by the transition effect of X seconds.

When “moving picture” or “audio” is selected in target selecting window 142, processing of reducing recording period S in ST209 by the transition effect duration of X seconds, is carried out, and recording of video and audio after “resume filming” is started, and so, as shown in FIG. 4, recording file A before “pause” and recording file D after “resume filming” are recorded such that recording file A and recording file D overlap for the transition effect duration of X seconds, moving picture and audio of recording file A recorded X seconds before “pause” and video and audio after “resume filming” overlap for the transition effect duration of X seconds.

When “image” or “sound” is selected in target selecting window 142, processing of reducing recording period S in ST209 is not carried out, and so, as shown in FIG. 5, recording file A before “pause” and recording file D after “resume filming” do not overlap, and the last image or sound in recording file A recorded immediately before “pause” and image or audio after “resume filming” overlap for the transition effect duration of X seconds.

In this way, according to Embodiment 1 of the present invention, video and audio recording apparatus 101 has: video input device 103 that captures a video signal being filmed; audio input device 104 that captures an audio signal being filmed; and transition effect section 106. Transition effect section 106 has: setting section 121 that registers transition effect processing; extracting section 122 that extracts area C or area C′ to be a target of combining, from recording file A where video and audio before “pause” are recorded, to RAM 127 and RAM 129 through “pause”; and transition effect processing section 131 that implements transition effect processing by combining the video signal and audio signal newly inputted from video input device 103 and audio device 104 through “resume filming” with area C or area C′ to be a target of combining. Therefore, it is possible to implement transition effect processing at the same time as filming without purchasing an expensive editing apparatus or without performing troublesome editing work using the editing apparatus after filming.

If the transition effect is set by transition effect setting screen 141, video and audio before “pause” and after “resume filming,” which have no temporal continuity, are connected smoothly by the transition effect.

By setting a transition effect by transition effect setting screen 141, the transition effect is provided every time filming is paused, and so a break of filming can be easily recognized.

Further, the video subjected to transition effect processing by transition effect processing section 131 of transition effect section 106 is displayed on display device 107 of video and audio recording apparatus 101, and the audio subjected to transition effect processing is outputted to audio output device 108, so that the video or audio subjected to transition effect processing can be confirmed in real time by displaying as a preview or outputting the video or audio. Therefore, the user can record only scenes where satisfactory transition effect is provided.

Transition effect setting screen 141 is displayed before “start filming,” and transition effect the user wants to implement during filming can be registered in advance, so that transition effect processing is implemented automatically during filming.

When filming is “paused,” transition effect setting screen 141 is displayed, and transition effect processing can be registered, re-registered or cancelled during filming, so that it is possible to continue filming while changing transition effects during filming.

Recording file A including recording file D is saved in recording medium 116 after “save as a file” is inputted from operating section 102, so that useless data is not recorded in recording medium 116.

### Embodiment 2

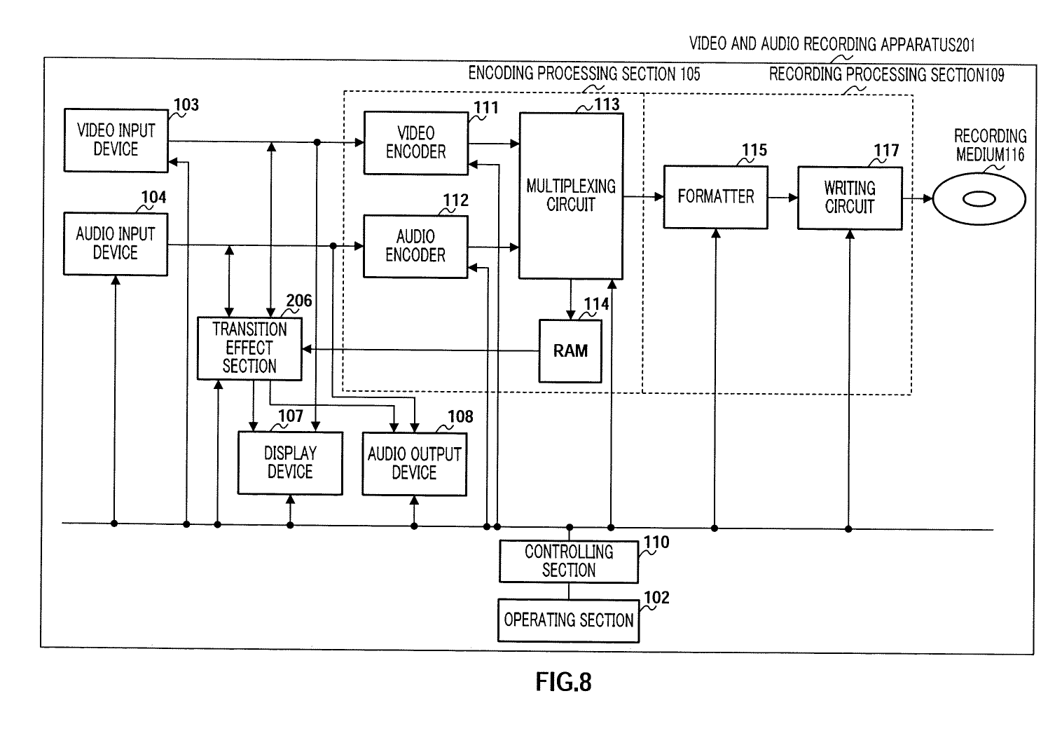

FIG. 8 is a block diagram showing the configuration of the video and audio recording apparatus according to Embodiment 2 of the present invention. In FIG. 8, the same components as those in the configuration diagram of video and audio recording apparatus 101 according to Embodiment 1 shown in FIG. 1 will be assigned the same reference numerals without further explanations. As shown in FIG. 8, transition effect section 206 of video and audio recording apparatus 201 of Embodiment 2 is different from transition effect section 106 of Embodiment 1.

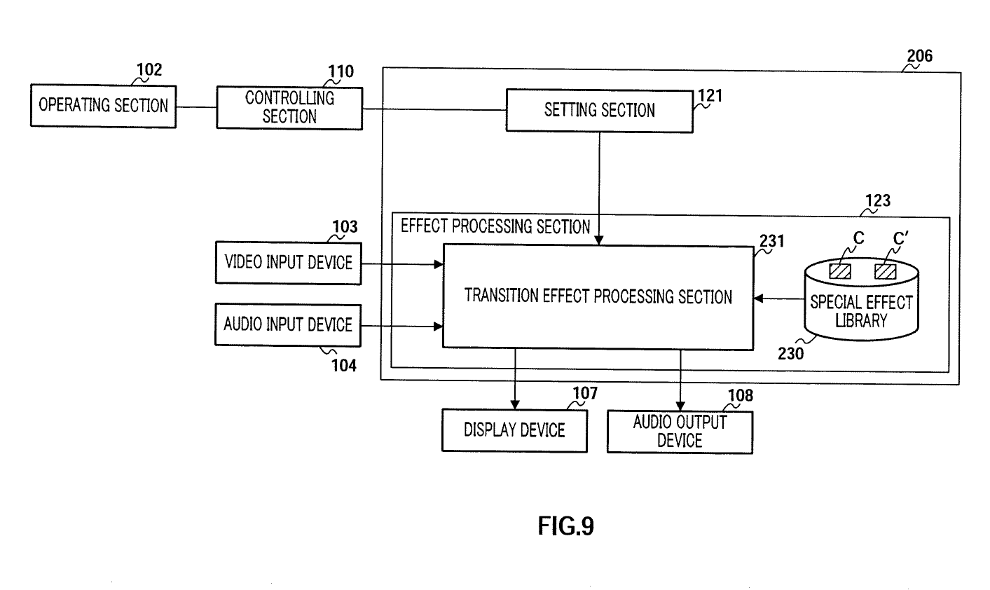

FIG. 9 is a block diagram showing the configuration of the transition effect section according to Embodiment 2 of the present invention. In FIG. 9, the same components as those in the configuration diagram of transition effect section 106 according to Embodiment 1 shown in FIG. 2 will be assigned the same reference numerals without further explanations.

As shown in FIG. 9, transition effect section 206 of Embodiment 2 does not have extracting section 122, and setting section 121 is directly connected to effect processing section 123. Special effect library 230 of effect processing section 123 sets, for example, a video signal and audio signal to be targets of combining processing in area C or area C′, and transition effect processing section 231 implements transition effect processing by combining the video signal and audio signal set in area C and area C′ with a video signal and audio signal newly inputted from video input device 103 and audio input device 104 through filming.

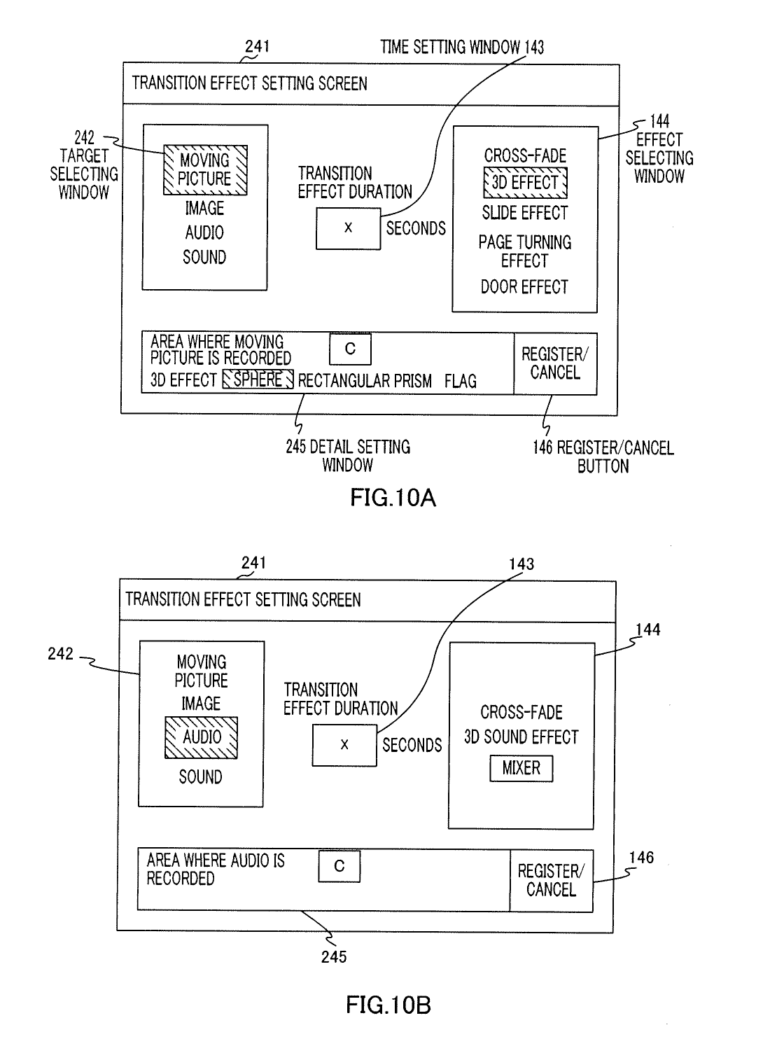

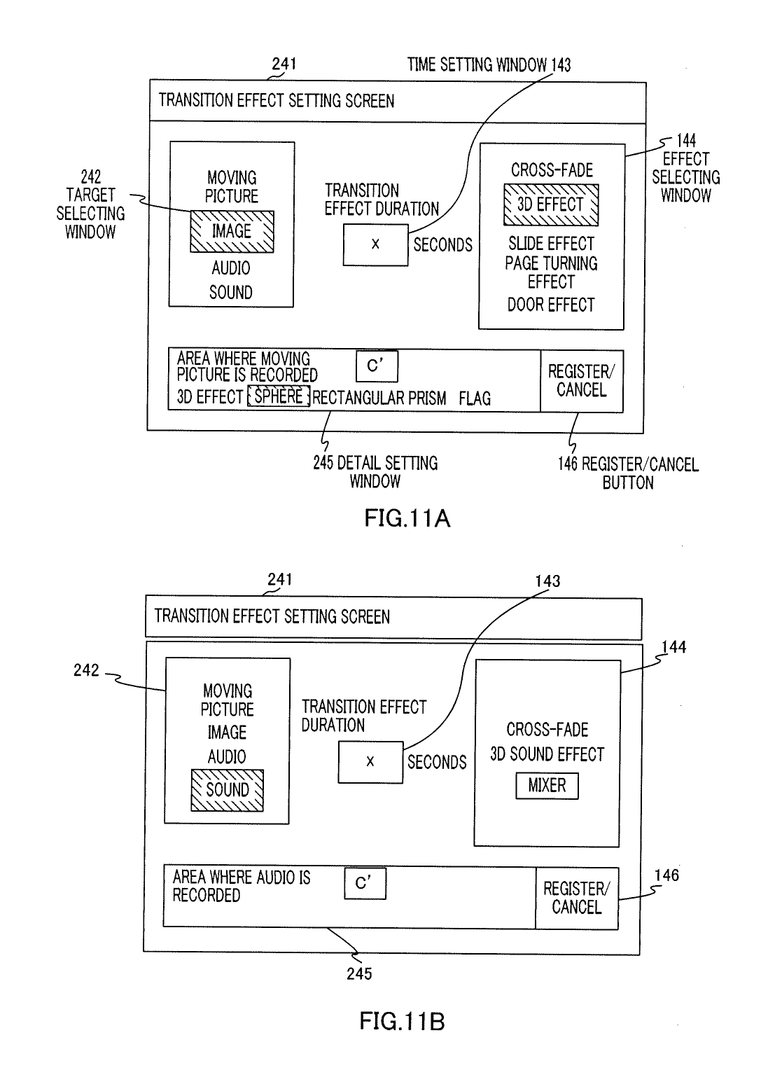

FIGS. 10A to 11B show examples of the transition effect setting screen according to Embodiment 2 of the present invention. In FIGS. 10A to 11B, the same components as those in the configuration diagram of transition effect setting screen 141 according to Embodiment 1 shown in FIGS. 3A and 3B will be assigned the same reference numerals without further explanations.

“Moving picture” shown in target selecting window 242 in FIGS. 10A to 11B represents that transition effect processing is implemented on video set in area C where moving picture of detail setting window 245 is recorded, as a target of combining, “image” represents that transition effect processing is implemented on image set in area C′ where image of detail setting window 245 is recorded, as a target of combining, “audio” represents that transition effect processing is implemented on audio set in area C where audio of detail setting window 245 is recorded, as a target of combining, and “sound” represents that transition effect processing is implemented on single sound set in area C′ where sound of detail setting window 245 is recorded, as a target of combining.

FIGS. 10A and 10B show examples of the transition effect setting screen according to Embodiment 2 of the present invention. As shown in FIG. 10A, the user selects “moving picture” in target selecting window 242 of transition effect setting screen 241 and sets a moving picture which is comprised of a video signal of X seconds to be a target of combining, in the area shown as area C where moving picture of detail setting window 245 is recorded.

As shown in FIG. 10B, the user selects “audio” in target selecting window 242 and sets audio which is comprised of an audio signal of X seconds to be a target of combining, in the area shown as area C where sound of detail setting window 245 is recorded.

The moving picture set in the area shown as area C where moving picture is recorded and the audio set in the area shown as area C where audio is recorded are moving picture and audio filmed in advance and may be video in recording file A being currently recorded, moving picture and audio recorded by the user using video and audio recording apparatus 201, moving picture and audio inputted from an external memory or the like, or moving picture and audio downloaded through communication network.

FIGS. 11A and 11B show examples of the transition effect setting screen according to Embodiment 2 of the present invention. As shown in FIG. 11A, the user selects “image” in target selecting window 242 of transition effect setting screen 241 and sets a single image to be a target of combining, in the area shown as area C′ where image of detail setting window 245 is recorded.

As shown in FIG. 11B, the user selects “sound” in target selecting window 242 and sets a single sound to be a target of combining, in the area shown as area C′ where sound of detail setting window 245 is recorded.

The image set in the area shown by area C′ where image is recorded and sound set in the area shown by area C′ where sound is recorded are image and sound filmed in advance, and may be image in recording file A currently being recorded, image and sound recorded by the user using video and audio recording apparatus 201, image and sound inputted from an external memory or the like, or image and sound downloaded through communication network.

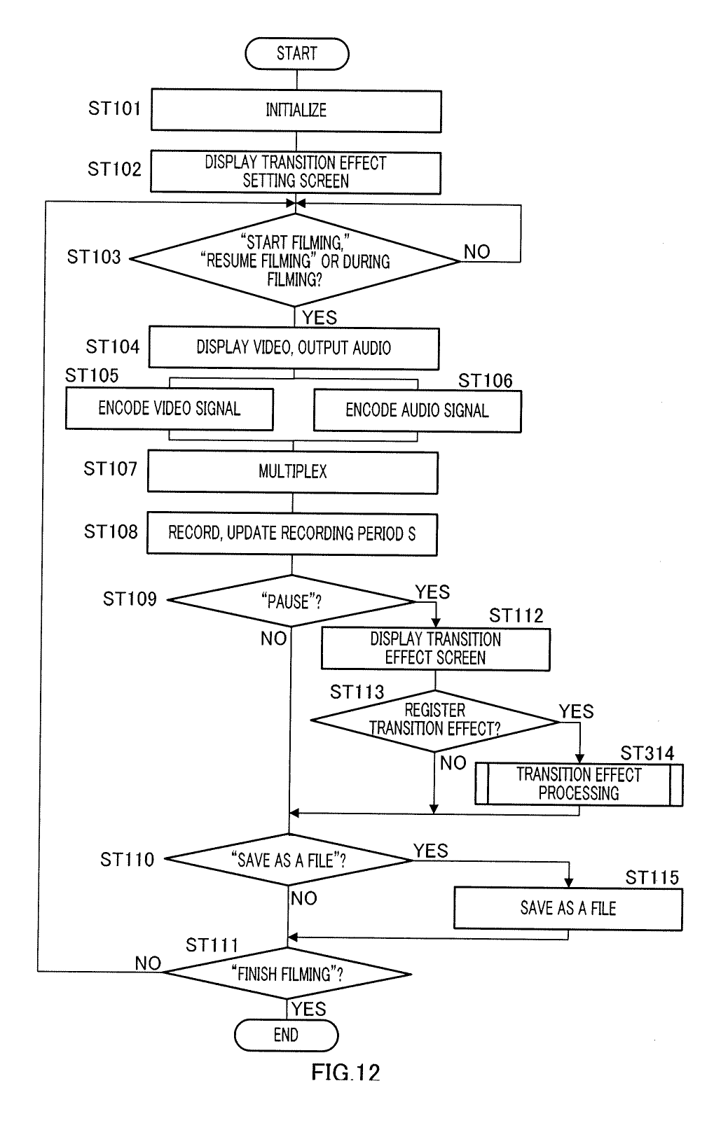

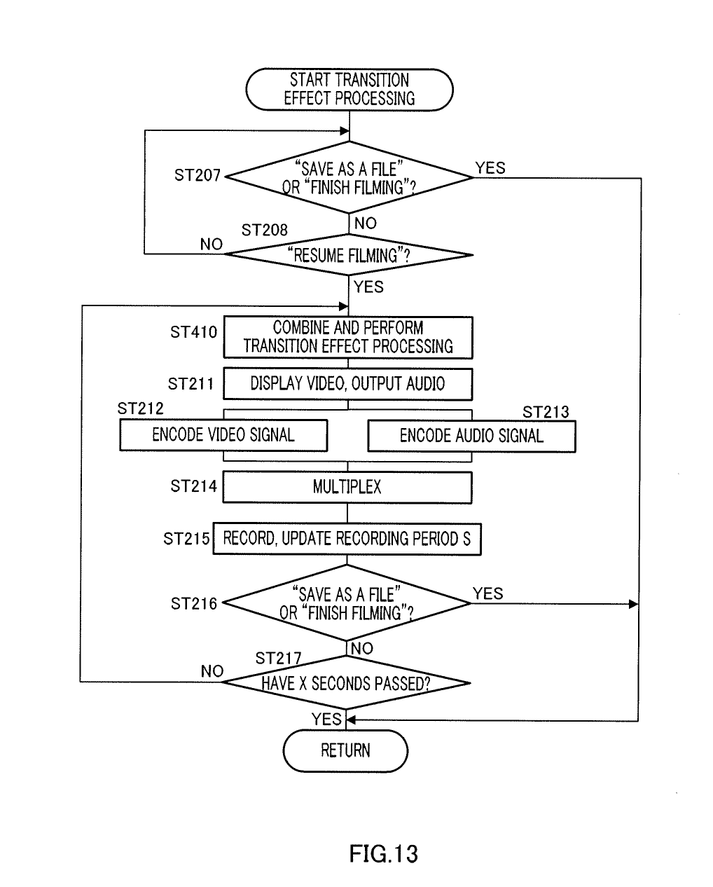

FIG. 12 is a flowchart illustrating the operation of the video and audio recording apparatus according to Embodiment 2 of the present invention. In the flowchart illustrating the operation of video and audio recording apparatus 201 shown in FIG. 12, the same processing steps as those in the flowchart illustrating the operation of video and audio recording apparatus 101 according to Embodiment 1 shown in FIG. 6 will be assigned the same reference numerals without further explanations.

In the flowchart illustrating the operation of video and audio recording apparatus 201, the transition effect processing in ST314 is different.

FIG. 13 is a flowchart illustrating the operation of the transition effect processing according to Embodiment 2 of the present invention. In the flowchart illustrating the operation of the transition effect processing shown in FIG. 13, the same processing steps as those in the flowchart illustrating the operation of the transition effect processing according to Embodiment 1 shown in FIG. 7 will be assigned the same reference numerals without further explanations.

The flowchart illustrating the operation of the transition effect processing is different from the flowchart illustrating the operation of the transition effect processing according to Embodiment 1 shown in FIG. 7 in that there is no step of extracting area C or area C′ to be a target of combining processings from ST201 to ST206, there is no processing of reducing recording period S for recording file A in ST209, and a video signal and audio signal to be targets of combining in transition effect processing in ST410 are set in area C and area C′ of special effect library 230 in advance.

In this way, according to Embodiment 2 of the present invention, the user can specify area C and area C′ to be targets of combining, and so the area to be a target of combining is not limited to immediately before “pause,” so that variations in a transition effect increase.

Although, in Embodiment 2, data set in area C and area C′ to be a target of combining is a video signal and audio signal, the data to be set in area C and area C′ may be compressed and encoded video data and audio data, or a multiplexed stream of video and audio, if video and audio recording apparatus 201 has a section for demultiplexing the multiplexed stream and a section for decoding video data and audio data.

Although, in Embodiment 2, transition effect processing is implemented by combining video data or audio data recorded after “resume filming” with other video data and audio data, it is also possible to combine video data and audio data recorded before “resume filming” with other video data and audio data and connect them to the video data and audio data recorded after “pause.”

It is also possible to combine video data and audio data recorded before and after “resume filming” with other data and connect them to video data and audio data recorded before and after “pause.”

Although, in Embodiment 2, transition effect processing is implemented by combining video data or audio data recorded after “resume filming” with other video data and audio data, it is also possible to implement special effect processing such as fade-in, fade-out and motion blur, without combining video data and audio data recorded after “resume filming” with other data, and connect them with video data and audio data recorded before “pause.”

In addition, it is also possible to implement special effect processing such as fade-in, fade-out and motion blur without combining video data and audio data recorded before and after “resume filming” and connect them with video data and audio data recorded before and after “pause.”

The present application is based on Japanese Patent Application No. 2005-276533, filed on Sep. 22, 2005, the entire content of which is expressly incorporated by reference herein.

### INDUSTRIAL APPLICABILITY

The video and audio recording apparatus according to the present invention provides an advantage of enabling transition effect processing at the same time as filming in a simple manner, and is useful as a compact video and audio recording apparatus which cannot edit after filming, such as mobile phones provided with a function of recording video and audio, and a video and audio recording method.

1-8. (canceled)

9. A video and audio recording apparatus comprising:
an input device that captures video data and audio data being filmed;
a transition effect registering section that registers a transition effect of connecting video data and audio data before and after filming is paused;
an editing section that, when the filming is paused and then resumed, superimposes video data and audio data recorded in a predetermined time period until the filming is paused and video data and audio data recorded in the predetermined time period after the filming is resumed, and edits the video data and audio data according to the transition effect registered by the transition effect registering section; and
a recording section that records the video data and audio data edited by the editing section.

10. The video and audio recording apparatus according to claim 9, wherein the editing section superimposes video data and audio data recorded in the predetermined time period immediately before the filming is paused and video data and audio data recorded in the predetermined time period after the filming is resumed, and edits the video data and audio data according to the transition effect.

11. The video and audio recording apparatus according to claim 9, wherein the editing section superimposes video data and audio data of the predetermined time period specified in advance and video data and audio data recorded in the predetermined time period after the filming is resumed, and edits the video data and audio data according to the transition effect.

12. A video and audio recording apparatus comprising:
an input device that captures video data and audio data being filmed;
a transition effect registering section that registers a transition effect of connecting video data and audio data before and after filming is paused;
an editing section that, when the filming is paused and then resumed, superimposes video data and audio data specified in advance and video data and audio data recorded in a predetermined time period after the filming is resumed, and edits the video data and audio data according to the transition effect; and
a recording section that records the video data and audio data edited by the editing section.

13. A video and audio recording method comprising:
an inputting step of capturing video data and audio data being filmed;
a transition effect registering step of registering a transition effect of connecting video data and audio data before and after filming is paused;
an editing step of, when the filming is paused and then resumed, superimposing video data and audio data recorded in a predetermined time period until the filming is paused and video data and audio data recorded in the predetermined time period after the filming is resumed, and editing the video data and audio data according to the transition effect registered in the transition effect registering step; and
a recording step of recording the video data and audio data edited in the editing step.
